(19) United States
(12) Patent Application Publication
(10) Pub. No.: US 2007/0186379 A1
(43) Pub. Date: Aug. 16, 2007

(54) Removable handle for trash vessel hinged access door

(76) Inventor: Kevin McDonald, Brush Prairie, WA (US)

Correspondence Address: David E. Orr, 7907 NE St Johns Rd, Vancouver, WA, 98665, US

(21) Appl. No.: 11/654,070

(22) Filed: Jan. 17, 2007

Related U.S. Application Data
(60) Provisional application No. 60/759,741, filed on Jan. 19, 2006.

(51) Int. Cl. E05B 1/00

(52) U.S. Cl. 16/110.1

(57) ABSTRACT

A removable handle assembly mounted on a pivotally attached enclosure member of a trash receptacle wherein the enclosure member rotates into and out of a covering or enclosing relationship relative to an opening through which garbage, debris, etc. is passed into the interior of the trash receptacle. The handle assembly comprises: (a) a connector that is attached to the enclosure member, the connector configured to receive (b) a removable outwardly and upwardly positioned contact member configured to engage the connector. The configuration and disposition of the handle assembly allows the user's hand or other body member to be positioned out of the way of direct contact with any trash, garbage, etc. being passed through the access opening into the interior of the trash bin as well as eliminating the need to touch the exterior surface of the closure member when positioning the closure member into an open position. The contact member may be removed by disengaging from the connector so that the contact member may be cleaned or replaced.

### FIELD

The invention relates to handles for enclosures to trash bins or receptacles; more specifically the invention comprises a removable handle that mounts to an opening member of a trash receptacle, the opening member partially enclosing and providing access to the receptacle.

### BACKGROUND

Trash bins or barrels, as found, for example, in fast food restaurants, are receptacles for the patron to place debris, unused food, trash, etc. Use of the trash receptacles involves the patron passing debris through an access opening, which is normally covered by a pivotally mounted enclosing member. First, to open the closure member, the patron normally places his hand against the exterior surface of the enclosure member and pushes it inward. The debris is then passed through the access provided by the enclosure opening. Unfortunately, this procedure frequently results in trash, debris, etc. coming in direct contact with the user's hand. Alternatively, the hand of the user engages a significantly large exterior surface of the closure member, which has been touched repeatedly by many patrons, thereby exposing the patron to germs or other contaminants.

In order to avoid such relatively unsanitary conditions, there is an obvious need for some type of handle assembly which allows the positioning of the patron hand, when opening the closure member to be clearly free of any contact with debris and also preferably out of direct contact with the exterior surface of the closure member itself.

Of particular interest is U.S. Pat. No. 5,398,374, by Betancourt, entitled “Handle Assembly for Trash Bin.” While this invention improves upon other prior art, it does not adequately protect the patron, since the handle described by Betancourt may become dirty and contaminated.

### SUMMARY

Representing a novel and unobvious improvement over Betancourt and other prior art, herein is disclosed a handle assembly that may be mounted on a pivotally attached enclosure member, such as a door to a trash receptacle wherein the enclosure member rotates into and out of a covering or enclosing relationship relative to an opening through which a patron may place or discard garbage, debris into the trash receptacle. The handle assembly comprises: (a) a connecting member that is more or less permanently attached to the enclosure member, the connector configured to receive (b) a removable outwardly and upwardly positioned contact member, an arm, configured to engage the connector. The configuration and disposition of the handle assembly allows the user's hand or other body member to be positioned out of the way of direct contact with any trash, garbage, etc. being passed through the access opening into the interior of the trash bin as well as eliminating the need to touch the exterior surface of the closure member when positioning the closure member into an open position. The contact member may be removed by disengaging from the connector so that the contact member may be cleaned or replaced.

The replaceable handle assembly will be seen to have several benefits, advantages and objects, among which are, the handle assembly obviates the requirement for a patron to touch debris or garbage.

Another object is a handle assembly that may be removed and cleaned, or even replaced.

The objects and advantages of the various aspects of the invention will appear in the disclosure to follow. In the disclosure reference is made to the accompanying drawings, which form a part hereof and in which is shown by way of illustration a single exemplary embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

FIG. 1 shows an embodiment of the removable handle mounted on the opening of a waste receptacle.

FIG. 2 shows the opening of the waste receptacle opened by operation of the removable handle.

FIG. 3 shows details of the construction of the removable handle. In this view the arm 122 is curved and configured to be used on a vertically placed door that opens upward or downward into a receptacle. It will be appreciated that a straight arm may also be used, the straight arm 122 adapted to be used on a door that opens downward, for example.

### DETAILED DESCRIPTION

### A First Embodiment

With reference to the accompanying figures, the handle assembly labeled as 100 is attached to and used in combination with a trash receptacle labeled as 200. The trash receptacle includes a housing or the like 210 having a hollow interior into which trash, or debris is placed or dumped. The trash or refuse is passed through an access opening 220, of sufficient size and dimension to allow passage of the trash into the receptacle. The access opening is covered by an enclosure member 230 that is hinged or pivotally attached at one peripheral edge 235. In general the enclosure member 230 pivots about a substantially horizontally oriented axis of rotation. Hinge members may be used to accomplish such pivotal attachment, or the enclosure member may be made as one piece with the housing 210, operating as a flap.

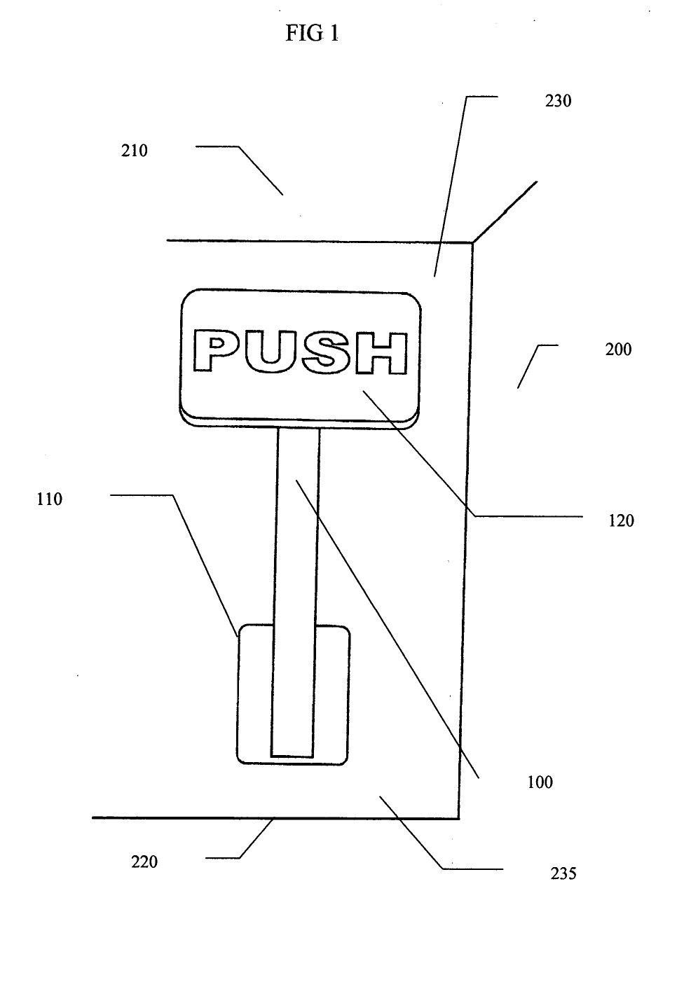

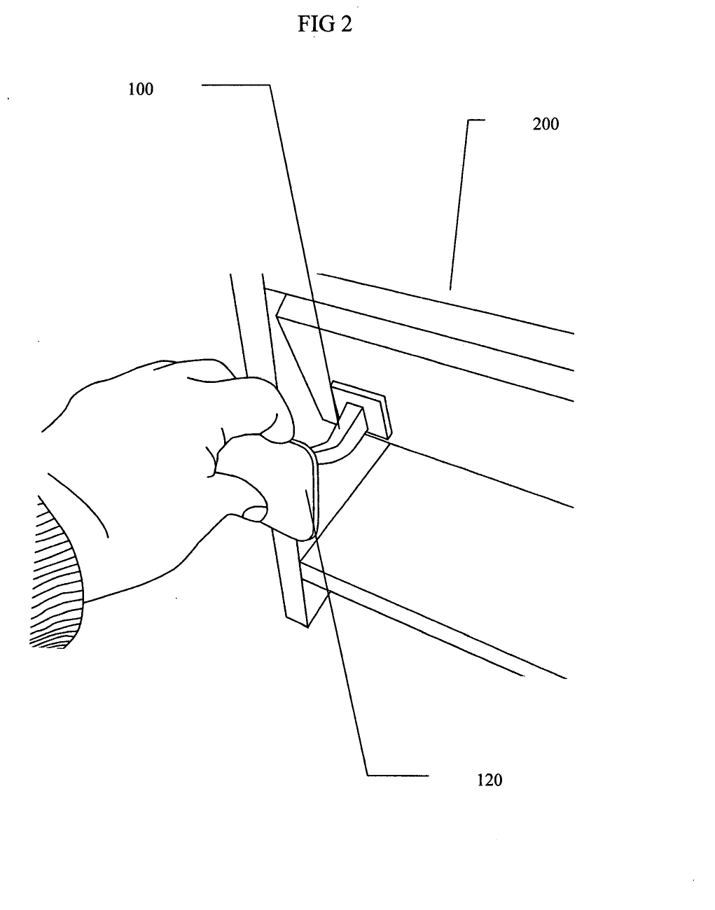

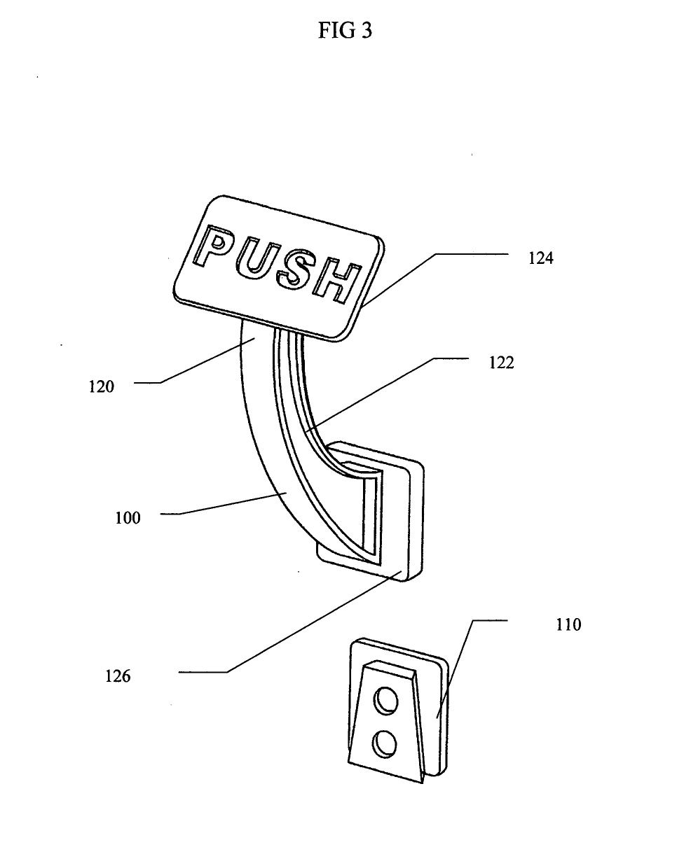

With reference to FIGS. 1-3, the handle assembly 100 includes a connector 110 that is more or less permanently connected or attached to the enclosure member 230. The handle assembly further comprises a contact member 120, being elongated and being mounted more or less in a horizontal orientation. The contact member 120 is made to permit either gripping or contact by the hand or other body part of a patron as shown in FIG. 3. To operate the handle, the patron engages the handle to exert a somewhat downward and inward pushing force on the contact member, which in turn causes the enclosure member 230 to pivot the enclosure member 230 out of its closed position relative to the access opening 220 and positions the patron's hand out of the way of the refuse, which passes through the access opening 220 into the interior of the trash bin 200.

The position of the contact member 120 is therefore well above and outwardly removed from the enclosure member 230 and more specifically the exterior surface thereof. This is accomplished through the provision of connecting means in the form of a connecting arm 122 that is removably received by and connected to the connector 110. The connecting arm has an outermost end 124 secured to or integrally formed as part of the contact member 120. An innermost end 126 of the connecting arm 122 is attached to the connector 110. The connector 110 functions as a mounting means, and may be in the form of a plate which may be connected to the enclosure member 230 or the exterior surface thereof by any type of conventional connector such as screws, bolts, etc.

With reference to FIG. 3, the connecting arm 122 is shown as a curved object. A variant of the arm 122, where the arm is straight, may be used on doors that open differently, or the arm 122 may be curved in a different manner, depending upon the geometry of the trash receptacle.

### DISCLOSURE SUMMARY

Aspects of the invention have been disclosed in terms of an exemplary embodiment. Given the foregoing disclosure, those skilled in the art of the present invention will be enabled to make modifications and alterations; however the scope of the invention with the various possible modifications and embodiments is most appropriately defined by the claims that follow.

I claim:

1. A removable handle assembly mounted on a pivotally attached enclosure member of a trash receptacle wherein the enclosure member rotates into and out of a covering or enclosing relationship relative to an opening through which garbage, debris, etc. is passed by a user into the interior of the trash receptacle, the handle assembly comprising:
a connector that is attached to the enclosure member; and
a removable outwardly and upwardly positioned contact member configured to engage and be received by the connector;
whereby the configuration and disposition of the handle assembly allows the user's hand or other body member to be positioned out of the way of direct contact with any trash, garbage, etc. being passed through the access opening, eliminating the need to touch the exterior surface of the closure member when positioning the closure member into an open position, and whereby the contact member may be removed.

2. A hand-operated handle for opening a pivoting door on a garbage receptacle, the handle mounted on said door and preventing the operating hand from contacting garbage within the receptacle, the handle comprising a mounting element, the mounting element attached to the door and configured to receive a handle arm, the handle arm having an engaging surface for pushing by the hand, whereby the arm is of sufficient length to keep the operating hand from contacting garbage within the receptacle when the door is opened by pushing the engaging surface.

3. A method for preventing a person's hand from contacting debris within a trash receptacle, wherein the debris is accessed through a pivoting door on the receptacle, the method comprising:
attaching a bracket to the pivoting door, the bracket having at least one slot;
attaching arm to the bracket, the arm having an element configured to be received in the slot, the arm extending away from the door when the door is opened.
